(19) United States
(12) Patent Application Publication
(10) Pub. No.: US 2016/0379262 A1
(43) Pub. Date: Dec. 29, 2016

(54) SERVICE SYSTEM AND METHOD FOR TRANSMITTING PUSH MESSAGE BASED ON USER LOCATION, USER EQUIPMENT AND NON-TRANSITORY COMPUTER READABLE STORAGE MEDIUM HAVING COMPUTER PROGRAM RECORDED THEREON

(71) Applicant: SK PLANET CO., LTD., Seongnam-si (KR)

(72) Inventors: Jung Min PARK, Seoul (KR); Jong Won WOO, Incheon (KR); Eun Su JEONG, Gwacheon-si (KR); Seul Ma Ro JEON, Seongnam-si (KR)

(21) Appl. No.: 14/942,770

(22) Filed: Nov. 16, 2015

(30) Foreign Application Priority Data
Jun. 24, 2015 (KR) 10-2015-0089902

(51) Int. Cl. G06Q 30/02; H04L 29/08; H04W 4/02

(52) U.S. Cl. CPC G06Q 30/0261; H04W 4/025; H04L 67/26; G06Q 30/0267

(57) ABSTRACT

Provided are a service system and a service method for transmitting a push message based on a user location, user equipment and a non-transitory computer readable storage medium having a computer program recorded thereon, and more particularly, a service system and a service method for transmitting a push message based on a user location, which determine the user location through WiFi information sensed by user equipment, determine a store visited by a user to correspond to the user location, and support the push message transmitted to correspond to the relevant store so as to be exposed only to the user positioned at the relevant store, and user equipment and a non-transitory computer readable storage medium recorded thereon.

### CROSS-REFERENCE TO RELATED APPLICATION

This application claims the benefit of Korean Application No. 10-2015-0089902 filed on Jun. 24, 2015 with the Korean Intellectual Property Office, the disclosure of which is incorporated herein by reference.

### BACKGROUND OF THE INVENTION

1. Field of the Invention

The present invention relates to a service system and a service method for transmitting a push message based on a user location, user equipment and a non-transitory computer readable storage medium having a computer program recorded thereon, and more particularly, to a service system and a service method for transmitting a push message based on a user location, which determine the user location through WiFi information sensed by user equipment, determine a store visited by a user to correspond to the user location, and support the push message transmitted to correspond to the relevant store so as to be exposed only to the user positioned at the relevant store, and user equipment and a non-transitory computer readable storage medium recorded thereon.

2. Description of the Related Art

In recent years, with the development of various communication technologies, various systems for increasing marketing efficiency by transmitting a push message including information such as an advertisement or a coupon associated with a store visited by a user is transmitted based on a user location have appeared.

When a server intends to transmit the push message to the user which visits a specific store, the store visited by the user needs to be accurately determined in order for functions of the systems to accurately operate.

To this end, the systems generally use a GPS or a BLE beacon, but reliability and accuracy of positional measurement deteriorate indoors in the case of the GPS and in the case of the BLE beacon, since additional equipment needs to be installed, system operation cost increases.

Further, even though the user location is determined, since the user location is transmitted to and stored in the server, there is a risk of exposure personal information of the user.

Accordingly, development of an alternative system for solving the problems is requested.

### PRIOR ART DOCUMENT

[Patent Document] Korean Patent Registration No. 10-0769456, titled “System and Method for Transmitting Reserved Location Based Message, and Mobile Terminal Applied to the Same”

### SUMMARY OF THE INVENTION

An object of the present invention is to increase accuracy and efficiency of transmitting a push message based on a user location by collecting store information depending on use of membership information corresponding to an affiliated store stored in user equipment and WiFi information associated with a WiFi AP sensed by the relevant affiliated store, accurately determining an affiliated store at which a user is currently positioned by comparing WiFi information currently sensed when the user revisits the affiliated store and the existing stored WiFi information with each other, and targeting and providing a message associated with the relevant affiliated store from a server by targeting the user who visits the affiliated store.

Further, another object of the present invention is to enforce security by preventing a user location from being exposed and increase accuracy and reliability of providing a message by accurately determining an affiliated store at which a user is positioned by user equipment and providing a message associated with the relevant affiliated store without sharing the user location with a server.

Characterized configurations of the present invention for achieving the objects of the present invention and peculiar effects of the present invention are as follows.

According to an aspect of the present invention, user equipment for a transmission service of a push message based on a user location includes: a membership management unit receiving membership information corresponding to an affiliated store from a server and storing the received membership information and determining whether the membership information is used at the affiliated store; a WiFi information management unit generating WiFi information associated with a WiFi AP sensed at the affiliated store at which a user is currently positioned by interlocking with a communication unit of the user equipment; a matching unit generating and storing matching information acquired by matching store information included in the membership information and the WiFi information at the time of using the membership information according to the determination of the membership management unit; and a mobile wallet control unit extracting store information regarding the affiliated store at which the user is currently positioned from the matching information including the WiFi information provided from the WiFi information management unit at the time of receiving a push message from the server and comparing positional information included in the extracted store information and positional information included in the push message with each other to expose the push message through the user equipment by considering whether the positional information of the extracted store information and the positional information of the push message coincide with each other.

Preferably, the membership information may include at least one of affiliated card information, coupon information, and point card information associated with the affiliated store.

Preferably, the WiFi information may include a BSSID for the WiFi AP.

Preferably, the mobile wallet control unit may extract the positional information extracted from the store information regarding the affiliated store at which the user is positioned and the positional information extracted from the push message and compare both the positional information extracted from the store information and the positional information extracted from the push message with each other and display the push message corresponding to the store information through the user equipment when both the positional information extracted from the store information and the positional information extracted from the push message coincide with each other.

Preferably, the membership management unit may receive usage information according to use of the membership information through the server that receives usage information according to recognition of the membership information from a POS device corresponding to the affiliated store and determine whether the membership information usage is used based on the usage information.

Preferably, the matching unit may generate matching information by matching the membership information corresponding to the usage information received from the server and the currently sensed WiFi information and store the generated matching information in the user equipment.

According to another aspect of the present invention, a service system for transmitting a push message based on a user location includes: a management server transmitting, at the time of receiving request information regarding a membership issuance request corresponding to an affiliated store from user equipment, membership information for the affiliated store to the user equipment, transmitting usage information according to use of the membership information to the user equipment at the time of using the membership information at the affiliated store, and transmitting a push message corresponding to the affiliated store to each user equipment receiving the membership information; and a mobile wallet application unit storing the membership information corresponding to the affiliated store received from the server, generating WiFi information associated with a WiFi AP sensed at the affiliated store at which a user is currently positioned by interlocking with a communication unit of the user equipment corresponding to a user as the user visits the affiliated store, generating matching information acquired by matching store information included in the membership information and the WiFi information at the time of receiving the usage information and storing the matching information, extracting store information for the affiliated store at which the user is currently positioned from matching information including WiFi information which coincides with the WiFi information associated with the WiFi AP sensed at the affiliated store when the user revisits the affiliated store, and exposing the push message by considering whether positional information included in the store information extracted at the time of receiving the push message and positional information included in the push message coincide with each other.

Preferably, the mobile wallet application unit may extract the positional information extracted from the store information regarding the affiliated store at which the user is positioned and the positional information extracted from the push message and compare both the positional information extracted from the store information and the positional information extracted from the push message with each other and display the push message corresponding to the store information through the user equipment when both the positional information extracted from the store information and the positional information extracted from the push message coincide with each other and automatically delete the push message when both the positional information extracted from the store information and the positional information extracted from the push message do not coincide with each other.

According to yet another aspect of the present invention, a service method for transmitting a push message based on a user location includes: receiving, by user equipment, membership information corresponding to an affiliated store from a mobile wallet server and storing the received membership information; generating, by the user equipment, WiFi information associated with a WiFi AP sensed at an affiliated store at which a user is positioned and determining whether the membership information is used at the affiliated store; generating and storing, by the user equipment, matching information acquired by matching store information included in the membership information and the WiFi information at the time of using the membership information; and retrieving, by the user equipment, matching information including WiFi information which coincides with the WiFi information associated with the WiFi AP sensed at the affiliated store when the user revisits the affiliated store and extracting store information for the affiliated store at which the user is currently positioned from the relevant matching information when the relevant matching information exists and comparing, at the time of receiving a push message corresponding to the affiliated store from the mobile wallet server, positional information included in the push message and positional information included in the store information with each other to expose the push message by considering whether both the positional information included in the push message and the positional information included in the store information coincide with each other.

According to still another aspect of the present invention, a non-transitory computer readable storage medium where programs for performing the service method for transmitting the push message based on the user location are recorded.

According to the present invention, an affiliated store at which a user is currently positioned is easily identified based on WiFi information and only a push message for the relevant affiliated store is supported to be selectively exposed to provide an advantage in terms of cost because a complicated configuration for determining a user location in the related art is not required like the related art and accurately determine an affiliated store visited by the user and expose a push message associated with the determined affiliated store, thereby significantly increasing promotion efficiency and accuracy associated with the affiliated store.

Further, according to the present invention, exposure of a push message which the user does not desire is prevented by automatically a push message not associated with the affiliated store at which the user is positioned to resolve inconvenience of the user due to indiscreet exposure of the push message.

Moreover, according to the present invention, the push message is supported to be selectively exposed only to the user positioned at the affiliated store associated with the push message only by transmitting a simple push message without verifying, point by point, at which affiliated store the user is positioned in a mobile wallet server to significantly improve convenience for transmission of the push message and increase advertisement efficiency depending on exposure of the push message.

Besides, according to the present invention, since user equipment can easily identify the affiliated store at which the user is positioned without sharing positional information of the user with other equipment or server, security for the user location can be significantly enforced.

Moreover, according to the present invention, since installation of a separate GPS or beacon for measuring an indoor location of the user is not requested to the affiliated store, cost for measuring the indoor location of the user is effectively saved.

### BRIEF DESCRIPTION OF THE DRAWINGS

FIG. 1 is a configuration environment diagram of a service system for transmitting a push message based on a user location according to an embodiment of the present invention.

FIG. 2 is a configuration diagram of user equipment for a transmission service of a push message based on a user location according to an embodiment of the present invention.

FIG. 3 is an exemplary diagram of a process for issuing membership information in the service system for transmitting a push message based on a user location according to an embodiment of the present invention.

FIG. 4 is an exemplary diagram of generation of matching information in the service system for transmitting a push message based on a user location according to the embodiment of the present invention.

FIG. 5 is an exemplary diagram of determination of information on a store at which a user is positioned in the service system for transmitting a push message based on a user location according to the embodiment of the present invention.

FIGS. 6 and 7 are exemplary diagrams of selective providing the push message based on the user location in the service system for transmitting a push message based on a user location according to the embodiment of the present invention.

FIG. 8 is a flowchart of a service method for transmitting a push message based on a user location according to an embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included. In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

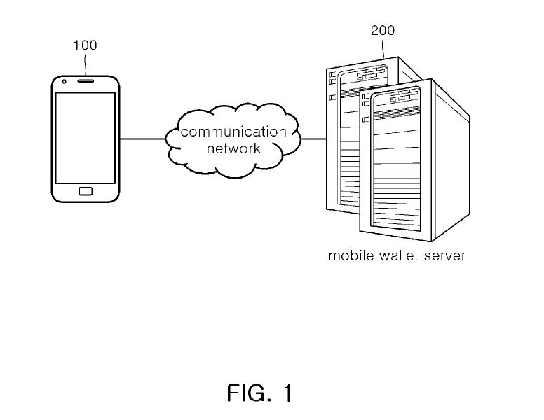

FIG. 1 is a configuration environment diagram of a service system for transmitting a push message based on a user location according to an embodiment of the present invention and as illustrated in FIG. 1, the service system may include a mobile wallet server 200 issuing membership information regarding an affiliated store desired by a user according to a user request and a user equipment 100 communicating with the mobile wallet server 200 through a communication network.

In the aforementioned configuration, the user equipment 100 may store the membership information regarding the affiliated store, which is received from the mobile wallet server 200 according to the membership issue request of the user and in this case, the membership information may include card information on any one of a credit card and a check card as an associated card associated the affiliated store or point card information in which a coupon, a mileage, and the like may be saved or used.

Further, the membership information further includes store information regarding the affiliated store and in this case, the store information may include an affiliated store name, the position of the affiliated store, or positional information regarding an address.

According to the aforementioned configuration, when the user visits the affiliated store, the user equipment 100 senses a wireless fidelity (WiFi) transmitted from a wireless fidelity access point (WiFi AP) 300 installed at the affiliated store and receives WiFi information from the WiFi AP 300 and when use such as payment, point using or saving, coupon using, and the like is performed through a point of sale (POS) device 400 installed at the affiliated store through the membership information stored in the user equipment 100, matching information corresponding to the affiliated store may be generated by matching the store information included in the membership information and WiFi information of the WiFi AP 300 installed at the affiliated store.

In this case, the WiFi information may include information on a basic service set identifier (BSSID), a signal intensity, a frequency, a media access control address (MAC) information, and the like set at the WiFi AP 300.

Meanwhile, the mobile wallet server 200 requests a membership for the aforementioned affiliated store based on membership information pre-stored in a DB to correspond to different users to transmit a push message regarding an advertisement, coupon providing, and the like corresponding to the aforementioned affiliated store to user equipment of each of different users that are issued with membership information through a communication network.

In this case, the push message may include the positional information on the affiliated store and the positional information may be constituted by the address or a positional code such as a coordinate.

As a result, when the user of the user equipment 100 that receives the push message transmitted from the mobile wallet server 200 revisits the affiliated store, the user equipment 100 may sense and receive the WiFi information from the WiFi AP 300 and compare each matching information generated to correspond to different affiliated stores and pre-stored in the user equipment 100 and the corresponding WiFi information and extract the store information from the WiFi information included in the matching information in each matching information and the currently sensed WiFi information.

Therefore, the user equipment 100 may determine and identify the affiliated store positioned by the user based on the extracted store information.

Thereafter, the user equipment 100 extracts the positional information from the push message received from the mobile wallet server 200 and compares the extracted positional information and the positional information included in the store information to determine whether both the extracted positional information and the positional information included in the store information coincide with each other.

As a result, when the positional information included in the push message and the positional information included in the store information coincide with each other, the user equipment 100 may determine the corresponding push message as the push message corresponding to the affiliated store visited by the user and the push message may be output and exposed through a display unit 140 of the user equipment 100.

According to the aforementioned configuration, the user equipment 100 that receives a push message corresponding to a specific affiliated store from the mobile wallet server 200 determines whether the user is currently positioned at the corresponding specific affiliated store to selectively expose the push message only when the user is positioned at the specific affiliated store, thereby increasing information providing efficiency to the user by exposing the push message related with the affiliated store which the user currently visits (at which the user is currently positioned) and preventing repulsion toward the push message due to indiscreet reception and exposure of the push message not desired by the user.

Further, the mobile wallet server 200 transmitting the push message also transmits the push message only to a user that is issued with a membership for the specific affiliated store and the push message is selectively exposed only to the user that visits the affiliated store according to the aforementioned configuration to increase efficiency for the affiliated store related advertisement and prevent user's dissatisfaction from being generated due to the transmission of the push message not desired by the user, thereby resolving a burden on the transmission of the push message.

Moreover, in the present invention, when the push message is transmitted to a user positioned at a specific location, the push message may be exposed to only a user which is accurately targeted by using the WiFi information stored in the user equipment 100.

As described above, in the present invention, the affiliated store at which the user is currently positioned is easily identified based on the WiFi information and only the push message for the relevant affiliated store is supported to be selectively exposed to provide an advantage in terms of cost because a complicated configuration for determining a user location in the related art is not required like the related art and accurately determine an affiliated store visited by the user and expose the push message associated with the determined affiliated store, thereby significantly increasing promotion efficiency and accuracy associated with the affiliated store.

Further, in the present invention, the mobile wallet server 200 need not continuously determine the user location in order to transmit the push message related with the affiliated store and the user equipment 100 exposes the push message related with the affiliated store through autonomous determination based on the user location, and as a result, there is no risk that the user location will be exposed to the outside, thereby enforcing security for the user location.

Meanwhile, in the aforementioned configuration, the user equipment 100 may include various terminals including a smart phone, a portable terminal, a mobile terminal, a personal digital assistant (PDA), a portable multimedia player (PMP) terminal, a telematics terminal, a navigation terminal, personal computer, a notebook computer, a slate PC, a tablet PC, an ultrabook, a wearable device (including for example, a watch type terminal (smart watch), a glass type terminal (smart glass), a head mounted display (HMD), and the like), a Wibro terminal, an Internet protocol television (IPTV) terminal, a smart TV, a digital broadcasting terminal, an audio video navigation (AVN) terminal, an audio/video (A/V) system, a flexible Terminal, and the like.

Further, the mobile wallet server 200 may be implemented in a form such as a web server, a database server, a proxy server, or the like.

Further, the a network load distribution mechanism or at least one of various software which allows a service device to operate on the Internet or other networks may be installed in the mobile wallet server 200 and therefore, the mobile wallet server 200 may be implemented as a computerized system.

Further, the network may be an http network and a private line, an intranet, or another predetermined network. Furthermore, connection of the mobile wallet server 200 and the user equipment 100 to be connected to a security network so that data is prevented from being attacked by a predetermined hacker or another third person. Further, the mobile wallet server 200 may include a plurality of database servers and may be implemented by a scheme in which the database servers are separately connected with the mobile wallet server 200 through a predetermined type of network connection including a distributed database server architecture.

Meanwhile, as described above, the user equipment 100 and the mobile server wallet 200 may communicate with each other through the communication network and examples of the communication network may include wireless communication networks including wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, and the like and wired communication networks including power line communication (PLC), USB communication, Ethernet, serial communication, optical/coaxial cable, and the like.

Further, the service system for transmitting the push message based on the user location may further include the POS device 400 and the WiFi AP 300 that communicate with the user equipment 100 and the mobile wallet server 200 through the relevant communication network.

In addition, a payment server (not illustrated) that performs payment processing depending on the membership information by communicating with the POS device 400 may be further included in the service system for transmitting the push message based on the user location and the relevant payment server may communicate with the mobile wallet server 200 through the communication network.

In this case, the payment server may include a credit card company server, a value added network (VAN) server, a telecommunication company server, and the like.

Hereinafter, a detailed configuration and a detailed operational embodiment of the user equipment 100 constituting the service system for transmitting the push message based on the user location according to the embodiment will be described with reference to drawings given below based on the aforementioned configuration.

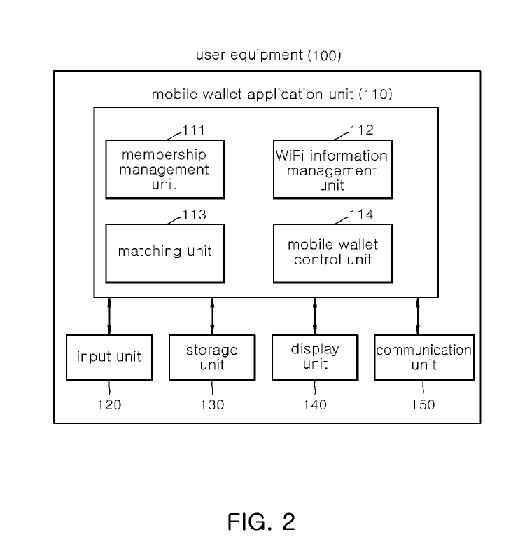

FIG. 2 is a detailed configuration diagram of user equipment 100 for a transmission service of a push message based on a user location according to an embodiment of the present invention.

As illustrated in FIG. 2, the user equipment 100 for the transmission service of the push message based on the user location may include a mobile wallet application unit 110, an input unit 120, a storage unit 130, a display unit 140, and a communication unit 150.

First, the mobile wallet application unit 110 communicates with the mobile wallet server 200 to receive various information and contents and display the received information and contents through the display unit 140 and display user input information received according to a user input through the input unit 120 through the display unit 140 or transmit the user input information to the mobile wallet server 200 through the communication unit 150.

Further, the mobile wallet application unit 110 stores mobile wallet related application data and the membership information issued from the mobile wallet server 200 in the storage unit 130 and loads the data stored in the storage unit 130 to provide the aforementioned service.

In this case, the mobile wallet application unit 110 may be constituted by a control unit including a RAM, a ROM, a CPU, a GPU, and a bus and executes and provides an overall control function of the user equipment 100 and the aforementioned service by using a program and data stored in the storage unit 130 through the control unit. In this case, the RAM, the ROM, the CPU, the GPU, and the like of the mobile wallet application unit 110 may be connected to each other through the bus. The CPU accesses the storage unit 130 to perform booting by using an operating system (O/S) stored in the storage unit 130 and perform various operations by using various programs, contents, data, and the like stored in the storage unit 130.

Meanwhile, the mobile wallet application unit 110 may include a membership management unit 111, a WiFi information management unit 112, a matching unit 113, and a mobile wallet control unit 114 as illustrated in FIG. 2.

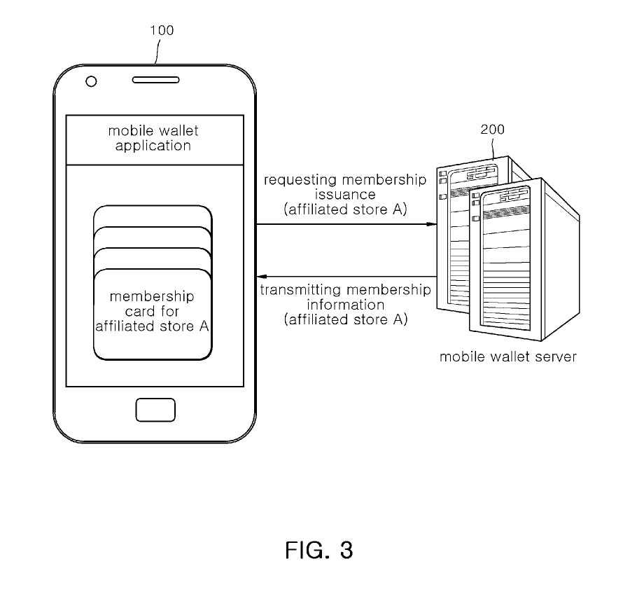

The membership management unit 111 may communicate with the mobile wallet server 200 through the communication unit 150 as illustrated in FIG. 3 and receive list information for information on memberships which may be issued to correspond to multiple affiliated stores from the mobile wallet server 200. As a result, the membership management unit 111 may display the corresponding list information through the display unit 140.

Further, the membership management unit 111 may transmit to the mobile wallet server 200 request information regarding an issuance request of the membership information selected by the user among the membership information included in the list information displayed through the display unit 140.

As a result, the mobile wallet server 200 may issue the membership information corresponding to the request information to correspond to the user and transmit the issued membership information to the user equipment 100 and the membership management unit 111 may store the membership information received from the mobile wallet server 200 in the storage unit 130.

In this case, the mobile wallet server 200 may match the issued membership information with the membership information of the user and store the membership information in the DB, therefore, the mobile wallet server 200 may verify a membership issuance history for each affiliated store of each user.

According to the aforementioned configuration, the membership management unit 111 may store and manage the membership information for each affiliated store in the storage unit 130.

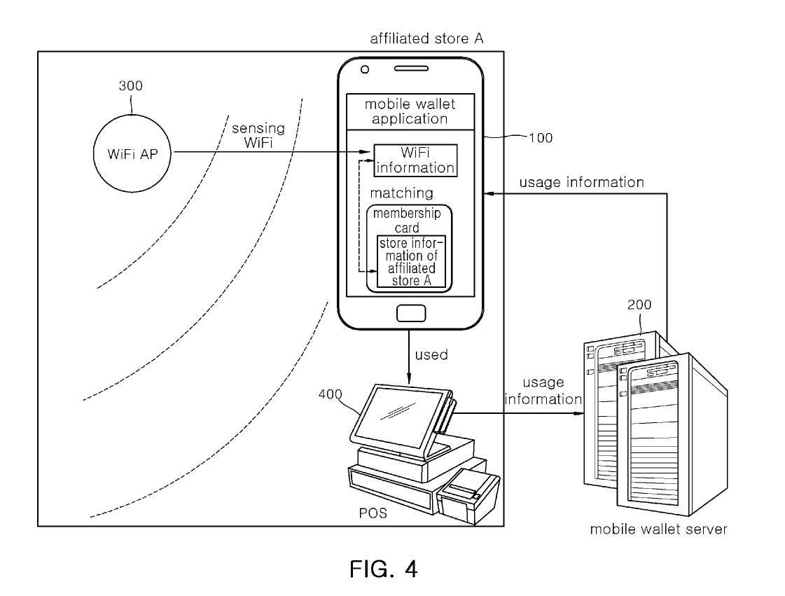

Meanwhile, as illustrated in FIG. 4, when the user visits an affiliated store affiliated with the mobile wallet server 200, the WiFi information management unit 112 may generate the WiFi information by sensing a WiFi signal of the WiFi AP 300 installed at the relevant affiliated store through the communication unit 150 configured in the user equipment 100 and store the WiFi information in the storage unit 130.

In this case, the WiFi information may include a BSSID, a frequency, a signal intensity, MAC information of the WiFi AP 300, and the like.

Meanwhile, the membership management unit 111 may determine whether the membership information is used at the relevant affiliated store visited by the user.

As one example, the membership management unit 111 may load membership information on affiliated store A at which the user is currently positioned based on a user selection input through the input unit 120 among the membership information for each of the multiple affiliated stores stored in the storage unit 130 and use a membership related mobile card according to the relevant membership information through communication with the POS device 400 installed at the affiliated store.

In this case, the membership related mobile card may include various types of mobile cards including a credit card, a check card, a point or mileage card, a barcode card, and the like.

Thereafter, the POS device 400 recognizes the membership information to transmit usage information according to use of the relevant membership information to the mobile wallet server 200 and in this case, the usage information may include identification information, used membership information, usage history information, and the like of the user equipment 100.

Herein, the identification information of the user equipment 100 may include a mobile directory number (MDN), a mobile IP, a mobile MAC, subscriber identity module (Sim) card unique information, a serial number, and the like, the used membership information may include mobile card related information (as one example, user related identification information, a credit card number, an expiration date, a credit card password, a barcode number, a coupon number, a mileage number, and the like), and the usage history information may include information on a payment amount, a used point or mileage, saved points or mileages, and the like.

Thereafter, the mobile wallet server 200 may update the membership related information corresponding to the usage information received from the POS device 400 and generate the usage information for the membership information corresponding to the usage information and transmit the generated usage information to the user equipment 100.

In this case, the POS device 400 may transmit payment information according to the use of the membership information to the aforementioned payment server through the aforementioned communication network and the mobile wallet server 200 receives the usage information according to the use of the membership information from the payment server to update membership related information of the user corresponding to the usage information and generates membership usage history information to match the generated membership usage history information with membership information of the relevant user and store the matched information in the DB.

Even in this case, the mobile wallet server 200 may generate the usage information of the membership information corresponding to the relevant usage information based on the usage information received from the payment server and transmit the generated usage information to the membership management unit 111 of the user equipment 100.

As a result, the membership management unit 111 may identify the membership information corresponding to the usage information received from the mobile wallet server 200 and determine whether the membership information is used through the identified membership information. That is, the membership management unit 111 may identify the membership information used to correspond to the affiliated store at which the user is currently positioned at the time of receiving the usage information.

In this case, when the membership management unit 111 communicates with the POS device 400 through the communication unit 150 of the user equipment 100 to enable autonomous processing (payment processing and point using processing) of the use of the membership information with the POS device 400, the membership management unit 111 may directly identify whether the membership information is used and the used membership information, of course.

Meanwhile, the matching unit 113 identifies the membership information used at affiliated store A according to determining, by the membership management unit 111, whether the membership information is used and thereafter, extracts store information corresponding to affiliated store A from the relevant membership information, receives the WiFi information generated by the WiFi information management unit 112 to correspond to the WiFi AP 300 of affiliated store A at which the user is currently positioned from the WiFi information management unit 112, and matches the WiFi information corresponding to affiliated store A and the store information extracted to correspond to affiliated store A each other to generate the matching information and store the generated matching information in the storage unit 130.

As such, the matching unit 113 may generate the matching information for each affiliated store visited by the user and store the generated matching information in the storage unit 130.

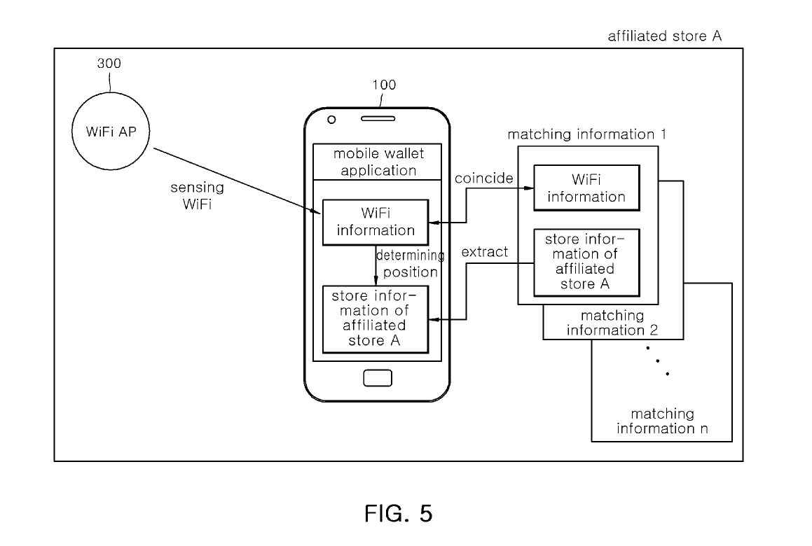

Meanwhile, according to the aforementioned configuration, the mobile wallet application unit 110 may match and store the store information regarding the affiliated store visited by the user and the WiFi information installed at the relevant affiliated store and identify the store visited by the user through the WiFi information and this will be described in detail with reference to FIG. 5.

As illustrated in FIG. 5, the mobile wallet control unit 114 included in the mobile wallet application unit 110 may receive the WiFi information generated based on the signal sensed through the WiFi AP 300 by interlocking with the WiFi information management unit 112 and compare the relevant WiFi information and the WiFi information included in each matching information stored in the storage unit 130.

In this case, when matching information including WiFi information which coincides with the WiFi information corresponding to the WiFi AP 300 installed at the affiliated store exists, the mobile wallet control unit 114 may extract the matching information and extract store information corresponding to the affiliated store at which the user is positioned from the extracted matching information.

Therefore, the mobile wallet control unit 114 may identify the affiliated store at which the user is currently positioned based on the extracted store information.

That is, when the user initially visits affiliated store A and thereafter, revisits affiliated store A again, the mobile wallet application unit 110 compares the WiFi information of the WiFi AP 300 installed at affiliated store A and the matching information generated to correspond to affiliated store A at the initial visitation to identify affiliated store A at which the user is currently positioned.

According to the aforementioned configuration, the mobile wallet application unit 110 may autonomously easily identify the affiliated store at which the user is currently positioned without a help of a separate device for determining the positional information, such as a global positioning system (GPS) or a Bluetooth low energy (BLE) beacon.

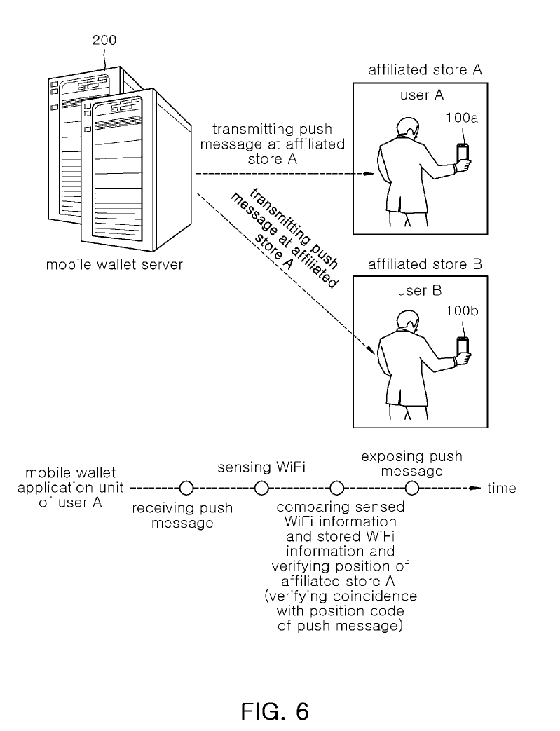

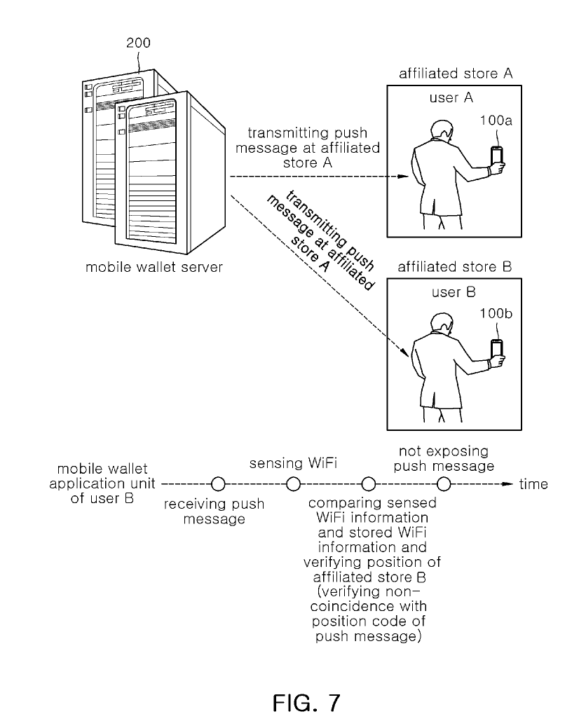

Meanwhile, the mobile wallet server 200 may transmit the push message to multiple users who are issued with the membership information to correspond to the specific affiliated store based on the membership information stored in the DB and the mobile wallet application unit 110 determines whether the push message received from the mobile wallet server 200 is the push message related with the affiliated store at which the user is currently positioned based on the aforementioned configuration and selectively exposes the push message to effectively target and provide the information related with the affiliated store to the relevant user and this will be described in detail through configurations of FIGS. 6 and 7.

As illustrated in Figures, the mobile wallet server 200 may determine the membership information of the affiliated store, which is issued for each user based on the membership information stored in the DB while matching the membership information and transmit the push message related with the relevant affiliated store to multiple users who are issued with the membership information for any one affiliated store among multiple affiliated stores.

In this case, the push message may include various pieces of information including affiliated store related advertisement information, coupon information, and the like.

Meanwhile, the mobile wallet control unit 114 configured in the mobile wallet application unit 110 of the user equipment 100 may extract the positional information in the store information extracted from the matching information corresponding to the WiFi information generated by sensing the signal transmitted from the WiFi AP 300 of the affiliated store at which the user is currently positioned as described above at the time of receiving the push message.

Further, the mobile wallet control unit 114 may extract the positional information included in the push message and compares the extracted positional information of the store information and the positional information of the push message with each other to determine whether both the positional information of the store information and the positional information of the push message coincide with each other.

As a result, when the positional information extracted from the store information and the positional information extracted from the push message coincide with each other, the mobile wallet control unit 114 may determine that the push message is the push message corresponding to the affiliated store at which the user is currently positioned and expose the relevant push message through the display unit 140 of the user equipment 100.

In this case, when the positional information extracted from the store information and the positional information extracted from the push message do not coincide with each other, the mobile wallet control unit 114 may determine that the relevant push message is a push message corresponding to another affiliated store and automatically delete the push message without exposing the push message through the display unit 140.

In the aforementioned configuration, the mobile wallet control unit 114 may identify the affiliated store at which the user is currently positioned by extracting the store information from the matching information corresponding to the WiFi information of the affiliated store before receiving the push message and immediately compare the store information extracted at the time of receiving the push message and the positional information of the push message of course.

FIGS. 6 and 7 are operational exemplary diagrams of the mobile wallet application unit 110 according to the aforementioned contents and as illustrated in FIGS. 6 and 7, when both user A positioned at affiliated store A by revisiting affiliated store A and user B positioned at affiliated store B by visiting affiliated store B have been issued with the membership information corresponding to affiliated store A, the mobile wallet server 200 may transmit the push message for affiliated store A to user A and user B.

In this case, as illustrated in FIG. 6, the mobile wallet application unit 110 configured in user equipment 100a of user A positioned at affiliated store A may extract the positional information from the relevant push message at the time of receiving the push message for affiliated store A of the mobile wallet server 200.

Further, the mobile wallet application unit 110 corresponding to user A may extract the matching information for affiliated store A corresponding to the WiFi information generated by sensing the signal transmitted from the WiFi AP 300 of affiliated store A at which the user is currently positioned among the matching information stored in the user equipment 100a of user A and extract the positional information from the store information for affiliated store A included in the relevant matching information.

Thereafter, the mobile wallet application unit 110 corresponding to user A compares the positional information of the push message and the positional information extracted from the store information with each other to determine whether the positional information of the push message and the positional information extracted from the store information coincide with each other and since both the push message and the store information include the positional information corresponding to affiliated store A, the mobile wallet application unit 110 corresponding to user A may expose the relevant push message through the display unit 140 of the user equipment 100a.

Therefore, the user may verify the push message related with affiliated store A which the user currently visits.

Meanwhile, as illustrated in FIG. 7, the mobile wallet application unit 110 configured in user equipment 100b of user B positioned at affiliated store B may also extract the positional information from the relevant push message at the time of receiving the push message for affiliated store A of the mobile wallet server 200.

Further, the mobile wallet application unit 110 corresponding to user B may extract the matching information for affiliated store B corresponding to the WiFi information generated by sensing the signal transmitted from the WiFi AP 300 of affiliated store B at which the user is currently positioned among the matching information stored in the user equipment 100b of user B and extract the positional information from the store information for affiliated store B included in the relevant matching information.

Thereafter, the mobile wallet application unit 110 corresponding to user B compares the positional information of the push message and the positional information extracted from the store information with each other to determine whether the positional information of the push message and the positional information extracted from the store information coincide with each other and since the push message includes the positional information of affiliated store A and the store information includes the positional information of affiliated store B, therefore, the positional information of affiliated store A and the positional information of affiliated store B do not coincide with each other, the mobile wallet application unit 110 corresponding to user B may automatically delete the relevant push message without exposing the relevant push message.

Therefore, the mobile wallet application unit 110 corresponding to user B does not expose a push message not related with affiliated store B which the user currently visits to automatically filter the push message not related with the affiliated store at which the user is currently positioned.

As described above, in the present invention, it is possible to easily determine the affiliated store which the user visits based on the WiFi information and only the push message related with the affiliated store at which the user is currently positioned among the push messages received from the mobile wallet server 200 is selectively exposed based on the determination to increase efficiency in providing the push message and exposure of a push message not desired by the user is prevented by automatically filtering a push message not related with the affiliated store at which the user is positioned to resolve inconvenience of the user in indiscriminately exposing the push message.

Moreover, according to the present invention, the push message is supported to be selectively exposed only to the user positioned at the affiliated store associated with the push message only by transmitting a simple push message without verifying, point by point, at which affiliated store the user is positioned in the mobile wallet server 200 to significantly improve convenience for transmission of the push message and increase advertisement efficiency depending on exposure of the push message.

Besides, according to the present invention, since the user equipment 100 may easily identify the affiliated store at which the user is positioned without sharing positional information of the user with other equipment or server, security for the user location may be significantly enforced.

Moreover, according to the present invention, since installation of a separate GPS or beacon for measuring an indoor location of the user is not requested to the affiliated store, cost for measuring the indoor location of the user is effectively saved.

Meanwhile, in the aforementioned configuration, the input unit 120 configured in the user equipment 100 receives a signal according to a button operation by the user or selection of a predetermined function or a command or control signal generated by an operation such as touching/scrolling a displayed screen or a signal corresponding to information input by the user and various devices including a keypad, a dome switch, a touch pad (capacitive/resistive), a touch screen, a jog wheel, a jog switch, a jog shuttle, a mouse, a stylus pen, a touch pen, and the like may be used.

Further, the display unit 140 may display various contents including various menu screens, and the like by using a user interface and/or a graphic user interface stored in the storage unit 130 by a control by the control unit (mobile wallet application unit).

Herein, the contents displayed on the display unit 140 include a menu screen including various texts or image data (including various information data) and data such as icons, a list menu, and a combo box, and the like. Further, the display unit 140 may be a touch screen.

In this case, the display unit 140 may include a touch sensor for sensing a touch gesture of the user. The touch sensor may be one of various types including a resistive type, a capacitive type, a piezoelectric type, and the like. In the case of the resistive type, when a part of a body of the user touches the surface of a touch screen by using a dielectric coated on the surface of the touch screen, a touch coordinate is calculated by sensing minute electricity excited to the body of the user. In the case of the capacitive type, two electrode plates are embedded in the touch screen and when the user touches the screen, upper and lower electrode plates at touched locations contact each other to allow current to flow and the flow of the current is sensed to calculate the touch coordinate.

Besides, the user equipment 100 may support a pen input function and in this case, the gesture of the user using not a part of body of the user but input means such as a pen may be sensed. As an example, when the input means is a stylus pen included in a coil, the user equipment 100 may include a magnetic field sensor for sensing a magnetic field which varies by the coil in the stylus pen. In this case, an approximate gesture of the user such as hovering in addition to the touch gesture of the user may be sensed.

Further, the display unit 140 may be implemented in at least one type of a liquid a liquid crystal display (LCD), a thin film transistor-liquid crystal display (TFT LCD), an organic light-emitting diode (OLED), a flexible display, a 3D display, an electronic ink (e-ink) display, and a light emitting diode (LED) and may include a driving circuit, a backlight unit, and the like together.

In addition, the display unit 140 may be configured as a 3D display unit displaying a 3D image.

A 3D display scheme such as a stereoscopic scheme (a glasses scheme), an auto stereoscopic scheme (a glass-free scheme), a projection scheme (a holographic scheme), or the like may be applied to the 3D display unit.

Further, the display unit 140 displays a credit card number, and the like of a mobile card (alternatively, including a mobile credit card, a check card, a prepaid card, and the like) issued from the mobile wallet server 200 or the payment server by the control of the control unit (mobile wallet application unit).

In addition, the user equipment 100 may further include a voice output unit and the relevant voice output unit outputs voice information included in a signal subjected to predetermined signal processing by the control unit (mobile wallet application unit). Herein, the voice output unit may include a receiver, a speaker, a buzzer, and the like.

Further, the voice output unit outputs a guide voice generated by the control unit (mobile wallet application unit).

In addition, the voice output unit outputs voice information corresponding to the credit card number, and the like of the mobile card (alternatively, including the mobile credit card, the check card, the prepaid card, and the like) issued from the mobile wallet server 200 or the payment server by the control of the control unit (mobile wallet application unit).

The communication unit 150 communicates with a predetermined internal component or at least one predetermined external terminal via a wired/wireless communication network. In this case, the predetermined external terminal may include a network service system, a server, and the like.

Further, the communication unit 150 may support wireless communication schemes including wireless LAN (WLAN), digital living network alliance (DLNA), wireless broadband (Wibro) 400, world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband (400) service (WMBS), Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, and the like. In addition, the communication unit 150 may support wired communication schemes including power line communication (PLC), USB communication, Ethernet, serial communication, an optical/coaxial cable, and the like.

Moreover, the storage unit 130 stores data and programs required to operate the user equipment 100.

That is, the storage unit 130 may store multiple application programs (application program or applications) driven by the user equipment 100, and data and commands for operating the user equipment 100. At least some of the application programs may be downloaded from an external server through wireless communication. Further, at least some of the application programs may exist on the user equipment 100 from the time of the release for basic functions (for example, telephone incoming and sending functions and message receiving and sending functions) of the user equipment 100. Meanwhile, the application program is stored in the storage unit 130 of the user equipment 100 and installed in the user equipment 100 to be driven so as to perform the operation (alternatively, function) of the user equipment 100 by the control unit (mobile wallet application unit) of the user equipment 100.

Further, the storage unit 130 may include at least one storage medium of a flash memory type, a hard disk type, a multimedia card micro type, a card type memory (for example, such as an SD or XD memory), a magnetic memory, a magnetic disk, an optical disk, a RAM, an SRAM, a ROM, an EEPROM, and a PROM. In addition, the user equipment 100 may operate a web storage performing a storage function of the storage unit 130 on the Internet or operate in association with the web storage.

Further, the storage unit 130 displays the credit card number, and the like of the mobile card (alternatively, including the mobile credit card, the check card, the prepaid card, and the like) according to the membership information issued from the mobile wallet server 200 or the payment server by the control of the control unit (mobile wallet application unit).

Moreover, the user equipment 100 may further include an interface unit (not illustrated) serving as an interface with all external devices connected to the relevant user equipment 100.

For example, the interface unit may be constituted by a wired/wireless headset port, an external charger port, a wired/wireless data port, a memory card port, a port connecting a device including an identification module, an audio input/output (I/O) port, a video input/output (I/O) port, an earphone port, and the like.

Herein, the identification module as a chip storing various pieces of information for authenticating a use authority of the user equipment 100 may include a user identity module (UIM), a subscriber identity module (SIM), a universal subscriber identity module (USIM), and the like. Further, the device including the identification module may be manufactured in a smart card type.

Accordingly, the identification module may be connected with the user equipment 100 through the port. Such an interface unit receives data from the external device or receives power to transfer each component in the user equipment 100 or transmit data in the user equipment 100 to the external device.

Further, when the user equipment 100 is connected with an external cradle, the interface unit may be a passage through which the power is supplied to the relevant user equipment 100 from the cradle or a passage through which various command signals input at the cradle by the user are transferred to the relevant user equipment 100. Various command signals input from the cradle or the relevant power may operate as a signal for recognizing that the user equipment 100 is accurately mounted on the cradle.

Further, the user equipment 100 may further include a separate input unit for receiving a signal according to operation of a button by the user or selection of a predetermined function or receiving a command or control signal generated by operation such as touching/scrolling a displayed screen.

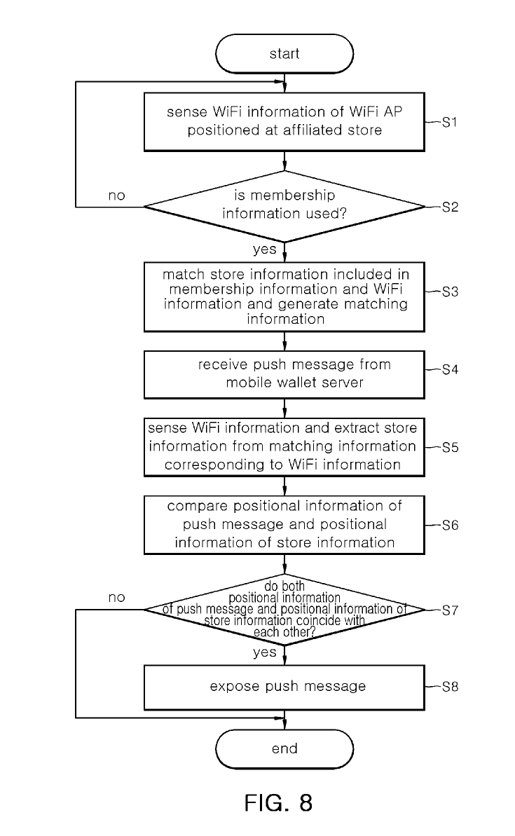

FIG. 8 is a flowchart of a service method for transmitting a push message based on a user location according to an embodiment of the present invention.

The user equipment 100 may communicate with the mobile wallet server 200 and receive list information for information on memberships which may be issued to correspond to multiple affiliated stores and display the relevant list information through the display unit 140.

Further, the user equipment 100 may transmit to the mobile wallet server 200 request information regarding an issuance request of the membership information selected by the user among the membership information included in the list information displayed through the display unit 140.

As a result, the mobile wallet server 200 may issue the membership information corresponding to the request information to correspond to the user and transmit the issued membership information to the user equipment 100 and the user equipment 100 may store the membership information received from the mobile wallet server 200 in the storage unit 130.

In this case, the mobile wallet server 200 may match the issued membership information with the membership information of the user and store the membership information in the DB, therefore, the mobile wallet server 200 may verify a membership issuance history for each affiliated store of each user.

According to the aforementioned configuration, the user equipment 100 may store and manage the membership information for each affiliated store.

Meanwhile, when the user visits an affiliated store affiliated with the mobile wallet server 200, the user equipment 100 may generate the WiFi information by sensing a WiFi signal of the WiFi AP 300 installed at the relevant affiliated store and store the WiFi information (S1).

In this case, the WiFi information may include a BSSID, a frequency, a signal intensity, MAC information of the WiFi AP 300, and the like.

Meanwhile, the user equipment 100 may determine whether the membership information is used at the relevant affiliated store visited by the user (S2).

As one example, the user equipment 100 may load membership information on affiliated store A at which the user is currently positioned based on a user input among the membership information for each of the multiple affiliated stores stored previously and use a membership related mobile card according to the relevant membership information through communication with the POS device 400 installed at the affiliated store.

In this case, the membership related mobile card may include various types of mobile cards including a credit card, a check card, a point or mileage card, a barcode card, and the like.

Thereafter, the POS device 400 recognizes the membership information to transmit usage information according to use of the relevant membership information to the mobile wallet server 200 and in this case, the usage information may include identification information, used membership information, usage history information, and the like of the user equipment 100.

Next, the mobile wallet server 200 may update the membership related information corresponding to the usage information received from the POS device 400 and generate the usage information for the membership information corresponding to the usage information and transmit the generated usage information to the user equipment 100.

In this case, the POS device 400 may transmit payment information according to the use of the membership information to the payment server through the communication network and the mobile wallet server 200 receives the usage information according to the use of the membership information from the payment server to update membership related information of the user corresponding to the usage information and generates membership usage history information to match the generated membership usage history information with membership information of the relevant user and store the matched information in the DB.

Even in this case, the mobile wallet server 200 may generate the usage information of the membership information corresponding to the relevant usage information based on the usage information received from the payment server and transmit the generated usage information to the user equipment 100.

As a result, the user equipment 100 may identify the membership information corresponding to the usage information received from the mobile wallet server 200 and determine whether the membership information is used through the identified membership information. That is, the membership management unit 111 may identify the membership information used at the affiliated store at which the user is positioned based on the relevant usage information at the time of receiving the usage information.

In this case, when the user equipment 100 communicates with the POS device 400 to enable autonomous processing (payment processing, point using processing, and the like) of the use of the membership information with the POS device 400, the user equipment 100 may directly identify whether the membership information is used and the used membership information, of course.

Meanwhile, the user equipment 100 identifies the membership information used at the affiliated store by determining whether the membership information is used and thereafter, extracts store information corresponding to the affiliated store from the relevant membership information and matches the WiFi information sensed from the WiFi AP 300 of the affiliated store at which the user is currently positioned and the store information with each other to generate and store matching information (S3).

As such, the user equipment 100 may generate the matching information for each affiliated store visited by the user and store the generated matching information.

Meanwhile, according to the aforementioned configuration, the user equipment 100 may match and store the store information regarding the affiliated store visited by the user and the WiFi information installed at the relevant affiliated store and identify the store visited by the user through the WiFi information.

The user equipment 100 may receive the WiFi information generated based on the signal sensed through the WiFi AP 300 and compare the relevant WiFi information and the WiFi information included in each matching information stored previously with each other.

In this case, when matching information including WiFi information which coincides with the WiFi information corresponding to the WiFi AP 300 installed at the affiliated store exists, the user equipment 100 may extract the matching information and extract store information corresponding to the affiliated store at which the user is positioned from the extracted matching information.

Therefore, the user equipment 100 may identify the affiliated store at which the user is currently positioned based on the extracted store information.

That is, when the user initially visits affiliated store A and thereafter, revisits affiliated store A again, the user equipment 100 compares the WiFi information of the WiFi AP 300 installed at affiliated store A and the matching information generated to correspond to affiliated store A at the initial visitation to identify affiliated store A at which the user is currently positioned.

Meanwhile, the mobile wallet server 200 may transmit the push message to multiple users who are issued with the membership information to correspond to the specific affiliated store based on the membership information stored in the DB and the user equipment 100 determines whether the push message received from the mobile wallet server 200 is the push message related with the affiliated store at which the user is currently positioned based on the aforementioned configuration to selectively expose the push message.

As one example, the mobile wallet server 200 may determine the membership information of the affiliated store, which is issued for each user based on the membership information stored in the DB while matching the membership information and transmit the push message for any one affiliated store among multiple affiliated stores to multiple users who are issued with the membership information for the relevant affiliated store (S4).

In this case, the push message may include various pieces of information including advertisement information, coupon information, and the like.

Meanwhile, the user equipment 100 may extract the positional information in the store information extracted from the matching information corresponding to the WiFi information generated by sensing the signal transmitted from the WiFi AP 300 of the affiliated store at which the user is currently positioned as described above at the time of receiving the push message (S5).

Further, the user equipment 100 may extract the positional information included in the push message and compares the positional information of the store information and the positional information of the push message with each other to determine whether both the positional information of the store information and the positional information of the push message coincide with each other (S6).

As a result, when the positional information extracted in the push message and the positional information extracted in the store information coincide with each other (S7), the user equipment 100 may determine the corresponding push message as the push message corresponding to the affiliated store at which the user is currently positioned and expose the relevant push message through the display unit 140 of the user equipment 100 (S8).

In this case, when the positional information extracted from the store information and the positional information extracted from the push message do not coincide with each other (S7), the user equipment 100 may determine that the relevant push message is a push message corresponding to another affiliated store and automatically delete the push message without exposing the push message through the display unit 140.

Therefore, the user equipment 100 compares a position according to the push message received from the mobile wallet server 200 and a position according to the store information regarding the affiliated store identified through the WiFi information with each other and when both positions coincide with each other, the user equipment may expose the relevant push message and when both positions do not coincide with each other, the user equipment 100 automatically filters the relevant push message to allow only the push message associated with the affiliated store visited by the user to be automatically exposed.

As described above, in the present invention, the affiliated store at which the user is currently positioned is easily identified based on the WiFi information and only the push message for the relevant affiliated store is supported to be selectively exposed to provide an advantage in terms of cost because a complicated configuration for determining a user location in the related art is not required like the related art and accurately determine an affiliated store visited by the user and expose the push message associated with the determined affiliated store, thereby significantly increasing promotion efficiency and accuracy associated with the affiliated store.

Further, according to the present invention, exposure of a push message which the user does not desire may be prevented by automatically a push message not associated with the affiliated store at which the user is positioned to resolve inconvenience of the user due to indiscreet exposure of the push message.

Moreover, according to the present invention, the push message is supported to be selectively exposed only to the user positioned at the affiliated store associated with the push message only by transmitting a simple push message without verifying, point by point, at which affiliated store the user is positioned in a mobile wallet server to significantly improve convenience for transmission of the push message and increase advertisement efficiency depending on exposure of the push message.

Besides, according to the present invention, since user equipment can easily identify the affiliated store at which the user is positioned without sharing positional information of the user with other equipment or server, security for the user location can be significantly enforced.

Moreover, according to the present invention, since installation of a separate GPS or beacon for measuring an indoor location of the user is not requested to the affiliated store, cost for measuring the indoor location of the user may be effectively saved.

The user equipment, the POS device, and various servers described above may be implemented by a hardware component, a software component, and/or a combination of the hardware component and the software component.

Further, the components described in the embodiments may be implemented by using one or more universal computers or special purpose computers like, for example, a processor, a controller, an arithmetic logic unit (ALU), a digital signal processor, a microcomputer, a field programmable array (FPA), a programmable logic unit (PLU), a microprocessor, or predetermined other devices that can execute and respond an instruction.

The user equipment, the POS device, and various servers may execute an operating system (OS) and one or more software applications executed on the operating system. Further, the user equipment, the POS device, and various servers may access, store, operate, process, and generate data in response to execution of software.

For convenience of understanding, it is described that each one component is used, but those skilled in the art can know that a processing device can include a plurality of processing elements and/or a plurality of types of processing elements.

For example, the user equipment, the POS device, and various servers may include a plurality of processors or one processor and one controller. Further, another processing configuration such as a parallel processor is also available.

The software may include a computer program, a code, an instruction, or one or more combinations thereof and arbitrarily operate or independently or collectively instruct the user equipment 100, the POS device, and various servers.

Software and/or data may be analyzed by the user equipment, the POS device, and various servers or permanently or temporarily embodied to a predetermined type of machine, component, physical device, virtual equipment, computer storage medium or device, or a signal wave in order to provide instructions or data to the user equipment, the POS device, and various servers.

The software may be distributed on a computer system connected through a network and stored or executed in a distribution method. The software and the data may be stored in one or more computer readable storage medium.

The service method for transmitting the push message based on the user location according to the embodiment of the present invention may be prepared with a computer program, and codes and code segments configuring the computer program may easily deduced by a computer programmer in the art. Further, the corresponding computer program is stored in a non-transitory computer readable storage media, and read and executed by the computer or the user equipment, the mobile wallet server, and the like according to the embodiment of the present invention to implement the service method for transmitting the push message based on the user location.

The non-transitory computer readable storage media include a magnetic storage medium, an optical storage medium, and a carrier wave medium. The computer program implementing the service method for transmitting the push message based on the user location according to the embodiment of the present invention may be stored and installed in the user equipment and an embedded memory of the mobile wallet server. Alternatively, an external memory such as a smart card storing and installing the computer program implementing the service method for transmitting the push message based on the user location according to the embodiment of the present invention may be mounted on the user equipment and the mobile wallet server through an interface.

According to the present invention, it is possible to easily determine the affiliated store which the user visits based on the WiFi information and only the push message related with the affiliated store at which the user is currently positioned among the push messages received from the mobile wallet server is selectively exposed based on the determination to increase efficiency in providing the push message and exposure of a push message not desired by the user is prevented by automatically filtering a push message not related with the affiliated store at which the user is positioned to resolve inconvenience of the user in indiscriminately exposing the push message and the present invention can be applied to various fields including an on-line shopping mall system field, a various electronic wallet management system field, a marketing system field, a user location based coupon providing system field, and the like.

Those skilled in the art can modify and change the above description within the scope without departing from an essential characteristic of the present invention. Accordingly, the embodiments disclosed herein are intended not to limit but to describe the technical spirit of the present invention, and the scope of the spirit of the present invention is not limited to the embodiments. The scope of the present invention should be interpreted by the appended claims and all technical spirit in the equivalent range is intended to be embraced by the appended claims of the present invention.

What is claimed is:

1. User equipment for a transmission service of a push message based on a user location, the user equipment comprising:
a membership management unit receiving membership information corresponding to an affiliated store from a server and storing the received membership information and determining whether the membership information is used at the affiliated store;
a WiFi information management unit generating WiFi information associated with a WiFi AP sensed at the affiliated store at which a user is currently positioned by interlocking with a communication unit of the user equipment;
a matching unit generating and storing matching information acquired by matching store information included in the membership information and the WiFi information at the time of using the membership information according to the determination of the membership management unit; and
a mobile wallet control unit extracting store information regarding the affiliated store at which the user is currently positioned from the matching information including the WiFi information provided from the WiFi information management unit at the time of receiving a push message from the server and comparing positional information included in the extracted store information and positional information included in the push message with each other to expose the push message through the user equipment by considering whether the positional information of the extracted store information and the positional information of the push message coincide with each other.

2. The user equipment of claim 1, wherein the membership information includes at least one of affiliated card information, coupon information, and point card information associated with the affiliated store.

3. The user equipment of claim 1, wherein the WiFi information includes a BSSID for the WiFi AP.

4. The user equipment of claim 1, wherein the mobile wallet control unit extracts the positional information extracted from the store information regarding the affiliated store at which the user is positioned and the positional information extracted from the push message, respectively, and compares both the positional information extracted from the store information and the positional information extracted from the push message with each other and displays the push message corresponding to the store information through the user equipment when both the positional information extracted from the store information and the positional information extracted from the push message coincide with each other.

5. The user equipment of claim 1, wherein the membership management unit receives usage information according to use of the membership information through the server that receives usage information according to recognition of the membership information from a POS device corresponding to the affiliated store and determines whether the membership information usage is used based on the usage information.

6. The user equipment of claim 5, wherein the matching unit generates matching information by matching the membership information corresponding to the usage information received from the server and the currently sensed WiFi information and stores the generated matching information in the user equipment.

7. A service system for transmitting a push message based on a user location, the service system comprising:
a management server transmitting, at the time of receiving request information regarding a membership issuance request corresponding to an affiliated store from user equipment, membership information for the affiliated store to the user equipment, transmitting usage information according to use of the membership information to the user equipment at the time of using the membership information at the affiliated store, and transmitting a push message corresponding to the affiliated store to each user equipment receiving the membership information; and
a mobile wallet application unit storing the membership information corresponding to the affiliated store received from the server, generating WiFi information associated with a WiFi AP sensed at the affiliated store at which a user is currently positioned by interlocking with a communication unit of the user equipment corresponding to a user as the user visits the affiliated store, generating matching information acquired by matching store information included in the membership information and the WiFi information at the time of receiving the usage information and storing the matching information, extracting store information for the affiliated store at which the user is currently positioned from matching information including WiFi information which coincides with the WiFi information associated with the WiFi AP sensed at the affiliated store when the user revisits the affiliated store, and exposing the push message by considering whether positional information included in the store information extracted at the time of receiving the push message and positional information included in the push message coincide with each other.

8. The service system of claim 7, wherein the mobile wallet application unit extracts the positional information extracted from the store information regarding the affiliated store at which the user is positioned and the positional information extracted from the push message and compares both the positional information extracted from the store information and the positional information extracted from the push message with each other and displays the push message corresponding to the store information through the user equipment when both the positional information extracted from the store information and the positional information extracted from the push message coincide with each other and automatically deletes the push message when both the positional information extracted from the store information and the positional information extracted from the push message do not coincide with each other.

9. A service method for transmitting a push message based on a user location, the service method comprising:
receiving, by user equipment, membership information corresponding to an affiliated store from a mobile wallet server and storing the received membership information;
generating, by the user equipment, WiFi information associated with a WiFi AP sensed at an affiliated store at which a user is positioned and determining whether the membership information is used at the affiliated store;
generating and storing, by the user equipment, matching information acquired by matching store information included in the membership information and the WiFi information at the time of using the membership information; and
retrieving, by the user equipment, matching information including WiFi information which coincides with the WiFi information associated with the WiFi AP sensed at the affiliated store when the user revisits the affiliated store and extracting store information for the affiliated store at which the user is currently positioned from the relevant matching information when the relevant matching information exists and comparing, at the time of receiving a push message corresponding to the affiliated store from the mobile wallet server, positional information included in the push message and positional information included respectively in the store information with each other to expose the push message by considering whether both the positional information included in the push message and the positional information included in the store information coincide with each other.
